(19) United States
(12) Patent Application Publication
(10) Pub. No.: US 2026/0188032 A1
(43) Pub. Date: Jul. 2, 2026

(54) IMAGE DESCRIPTION METHOD AND RELATED DEVICE

(71) Applicant: TENCENT TECHNOLOGY (SHENZHEN) COMPANY LIMITED, Shenzhen (CN)

(72) Inventors: Junxian CAI, Shenzhen (CN); Junfeng HE, Shenzhen (CN); Xi CHEN, Shenzhen (CN)

(73) Assignee: TENCENT TECHNOLOGY (SHENZHEN) COMPANY LIMITED, Shenzhen (CN)

(21) Appl. No.: 19/551,934

(22) Filed: Feb. 27, 2026

Related U.S. Application Data
(63) Continuation of application No. PCT/CN2024/108314, filed on Jul. 30, 2024.

(30) Foreign Application Priority Data
Nov. 9, 2023 (CN) 202311492000.3

(51) Int. Cl. G06V 20/70; G06F 40/166; G06V 10/40; G06V 10/764

(52) U.S. Cl. CPC G06V 20/70; G06F 40/166; G06V 10/40; G06V 10/764

(57) ABSTRACT

An image description method includes obtaining an image; obtaining an image description model and a description prompt text, the description prompt text indicating an image description rule for performing image description by the image description model; inputting the description prompt text and the image into the image description model; and performing image description on the image based on the description prompt text through the image description model, to obtain a first image description text that conforms to the image description rule. The description prompt text is obtained by correcting an initial prompt text corresponding to the image description rule based on a first text difference between a sample image description text and a predicted image description text. The sample image description text is obtained based on a sample image and the image description rule. The predicted image description text is obtained by the image description model performing image description on the sample image based on the initial prompt text. The initial prompt text is initialized based on the image description rule.

### CROSS REFERENCE TO RELATED APPLICATIONS

This application is a bypass continuation application of International Patent Application No. PCT/CN2024/108314 , filed on Jul.y30, 2024, which claims priority to and is based on Chinese Patent Application No. 2023114920003, filed on November 09, 2023, the disclosures of which are incorporated herein in their entireties by reference.

### FIELD

The disclosure relates to the field of computer technologies, and in particular, to an image description method and a related device.

### BACKGROUND

Image annotation is a process of marking and describing an object, an area, or a feature in an image. The image annotation is an important task in a computer in a field of vision, and is configured for adding semantic and contextual information to image data, so that the computer can understand and process image content.

When an image needs to be annotated or described, information such as a candidate box and a classification of the image is identified through an image annotation tool, for example, an open-source tool such as Labelimg or ImgLab, and then description information related to the candidate box and the classification is obtained.

However, when many images that need to be described and annotated exist, a large quantity of network resources need to be consumed through the foregoing tool to identify the information such as the candidate box and the classification of the image and then obtain related description information, which easily causes a waste of the network resources.

### SUMMARY

Provided are an image description method and a related device. The related device may include an image description apparatus, an electronic device, a computer-readable storage medium, and a computer program product. A large quantity of network resources do not need to be consumed to identify information such as candidate boxes and classifications of images, thereby avoiding a waste of network resources and saving network resources.

According to an aspect of some embodiments of the present disclosure, a method includes obtaining an image; obtaining an image description model and a description prompt text, the description prompt text indicating an image description rule for performing image description by the image description model; inputting the description prompt text and the image into the image description model; performing image description on the image based on the description prompt text through the image description model, to obtain a first image description text that conforms to the image description rule. The description prompt text is obtained by correcting an initial prompt text corresponding to the image description rule based on a first text difference between a sample image description text and a predicted image description text. The sample image description text is obtained based on a sample image and the image description rule. The predicted image description text is obtained by the image description model performing image description on the sample image based on the initial prompt text. The initial prompt text is initialized based on the image description rule.

According to an aspect of some embodiments of the present disclosure, an image description apparatus includes at least one memory configured to store computer program code and at least one processor configured to read the program code and operate as instructed by the program code, the program code comprising first obtaining code figured to cause the at least one of the at least one processor to obtain an image; second obtaining code configured to cause at least one of the at least one processor to obtain an image description model and a description prompt text, the description prompt text indicating an image description rule for performing image description by the image description model; and third obtaining code configured to cause at least one of the at least one processor to input the description prompt text and the image into the image description model; and perform image description on the image based on the description prompt text through the image description model to obtain a first image description text that conforms to the image description rule. The description prompt text is obtained by correcting an initial prompt text corresponding to the image description rule based on a first text difference between a sample image description text and a predicted image description text. The sample image description text is obtained based on a sample image and the image description rule. The predicted image description text is obtained by the image description model performing image description on the sample image based on the initial prompt text. The initial prompt text is initialized based on the image description rule.

According to an aspect of some embodiments of the present disclosure, a non-transitory computer-readable storage medium, storing computer code which, when executed by at least one processor, causes the at least on processor to at least obtain an image; obtain an image description model and a description prompt text, the description prompt text indicating an image description rule for performing image description by the image description model; input the description prompt text and the image into the image description model; perform image description on the image based on the description prompt text through the image description model, to obtain a first image description text that conforms to the image description rule. The description prompt text is obtained by correcting an initial prompt text corresponding to the image description rule based on a first text difference between a sample image description text and a predicted image description text. The sample image description text is obtained based on a sample image and the image description rule. The predicted image description text is obtained by the image description model performing image description on the sample image based on the initial prompt text. The initial prompt text is initialized based on the image description rule.

Then, the to-be-described image may be annotated through the first image description text, which can reduce complexity in an image annotating process, thereby improving image annotating efficiency.

### BRIEF DESCRIPTION OF THE DRAWINGS

To describe technical solutions of some embodiments more clearly, drawings required for describing some embodiments are briefly described below. Apparently, the drawings in the following description show only some embodiments, and a person skilled in the art may derive other drawings from the drawings without creative efforts.

FIG. 1 is a schematic diagram of a scenario of an image description method according to some embodiments.

FIG. 2a is a flowchart of an image description method according to some embodiments.

FIG. 2b is a schematic diagram of an image description rule according to some embodiments.

FIG. 2c is another schematic diagram of an image description rule according to some embodiments.

FIG. 3 is a schematic flowchart of iteration of an image description model according to some embodiments.

FIG. 4 is a schematic diagram of a description text adjustment interface according to some embodiments.

FIG. 5 is a schematic flowchart of iteration of an image description model according to some embodiments.

FIG. 6 is a schematic diagram of a comparison of efficiency between manual image description and image description through an image description model according to some embodiments.

FIG. 7 is another flowchart of an image description method according to some embodiments.

FIG. 8 is a schematic data flowchart of image description according to some embodiments.

FIG. 9 is a schematic diagram of establishing an image description model according to some embodiments.

FIG. 10 is a schematic structural diagram of an image description apparatus according to some embodiments.

FIG. 11 is a schematic structural diagram of an electronic device according to some embodiments.

### DETAILED DESCRIPTION

Technical solutions in embodiments of this disclosure are clearly and completely described below with reference to accompanying drawings in some embodiments. Apparently, the described embodiments are merely some rather than all of some embodiments. All other embodiments obtained by a person skilled in the art based on some embodiments without creative efforts fall within the protection scope.

Other variations are within the spirit of the present disclosure. While the disclosed techniques are susceptible to various modifications and alternative constructions, certain illustrated embodiments are shown in the drawings and described above in detail. However, there is no intention to limit the disclosure to the specific forms disclosed. Rather, the intention is to cover all modifications, alternative constructions, and equivalents falling within the spirit and scope of the disclosure as defined in the appended claims.

In the following descriptions, related “some embodiments” describe a subset of all possible embodiments. However, it may be understood that the “some embodiments” may be the same subset or different subsets of all the possible embodiments, and may be combined with each other without conflict.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

The terms "first," "second," "third," and the like in the description and in the claims, if any, are used for distinguishing between similar elements and not necessarily for describing a sequential or chronological order. It is to be understood that the terms so used are interchangeable under appropriate circumstances. The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Some embodiments provide an image description method and a related device. The related device may include an image description apparatus, an electronic device, a computer-readable storage medium, and a computer program product. The image description apparatus may specifically be integrated in the electronic device. The electronic device may be a device such as a terminal or a server.

The image description method in some embodiments may be performed by the terminal, or may be performed by the server, or may be jointly performed by the terminal and the server. The foregoing examples are not to be construed as a limitation.

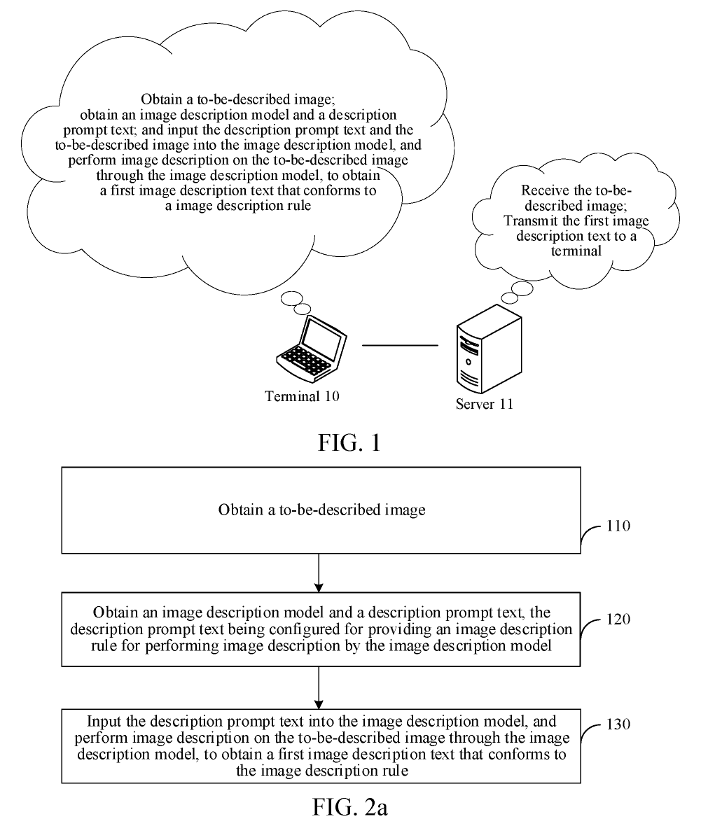

As shown in FIG. 1, an example in which the image description method is jointly performed by the terminal and the server is used. A model training system provided in some embodiments includes a terminal 10, a server 11, and the like. The terminal 10 and the server 11 are connected through a network, for example, through a wired or wireless network, and the image description apparatus may be integrated in the terminal.

The terminal 10 may be configured to: obtain a to-be-described image; obtain an image description model and a description prompt text, the description prompt text being configured for providing an image description rule for the image description model to perform image description; and input the description prompt text and the to-be-described image into the image description model, and perform image description on the to-be-described image through the image description model, to obtain a first image description text that conforms to an image description rule, the description prompt text being obtained by correcting an initial prompt text corresponding to the image description rule based on a first text difference between a sample image description text and a predicted image description text, the sample image description text being obtained based on a sample image and the image description rule, the predicted image description text being obtained by the image description model performing image description on the sample image based on the initial prompt text, and the initial prompt text being initialized based on the image description rule.

The terminal 10 may include a mobile phone, a smart voice interaction device, a smart home appliance, an onboard terminal, an aircraft, a tablet computer, a laptop, a personal computer (PC), or the like. The terminal 10 may be further provided with a client. The client may be an application client, a browser client, or the like.

The server 11 may be configured to: receive a to-be-described image transmitted by the terminal 10, and obtain an image description model and a description prompt text, the description prompt text being configured for providing an image description rule for the image description model to perform image description; and finally input the description prompt text and the to-be-described image into the image description model, and perform image description on the to-be-described image through the image description model, to obtain a first image description text that conforms to the image description rule, and transmit the first image description text to the terminal 10. The description prompt text is obtained by correcting an initial prompt text corresponding to the image description rule based on a first text difference between a sample image description text and a predicted image description text, the sample image description text is obtained based on a sample image and the image description rule, the predicted image description text is obtained by the image description model performing image description on the sample image, and the initial prompt text is initialized based on the image description rule.

The server 11 may be an independent physical server, a server cluster formed by a plurality of physical servers, a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In the image description method or apparatus, a plurality of servers may be grouped into a blockchain, and the servers are nodes on the blockchain.

Detailed descriptions are separately provided below. A description order of the following embodiments is not construed as a limitation on a preferred order of some embodiments.

An LLM is an abbreviation for a large language model. The large language model can simultaneously process a plurality of different media data, such as text, images, audio, and videos. Different media data is mixed to understand and generate related content more accurately.

This embodiment is described from a perspective of the image description apparatus. The image description apparatus may specifically be integrated in the electronic device. The electronic device may be a device such as the server or the terminal.

This embodiment is applicable to various scenarios such as a cloud technology, artificial intelligence, intelligent traffic, and assisted driving.

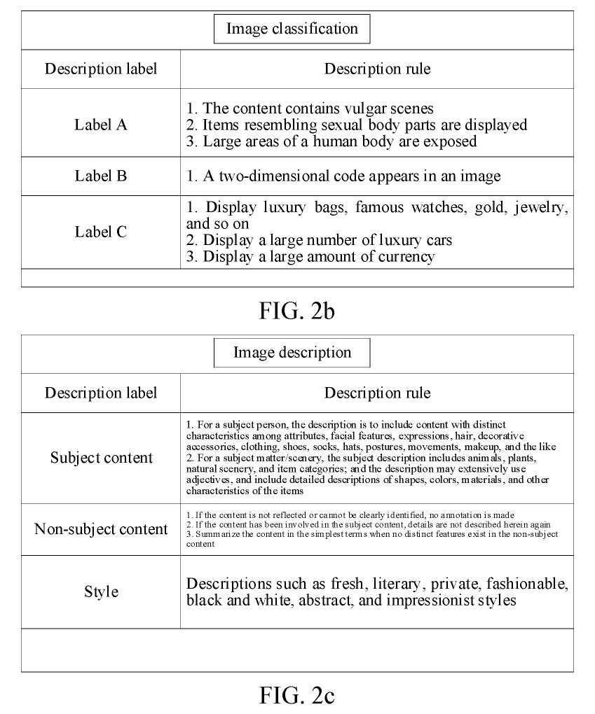

As shown in FIG. 2a, a specific process of the image description method may be as follows. In the following embodiments, operations may be performed sequentially, in a different order, in parallel, or with some operations skipped or repeated.

110: Obtain a to-be-described image.

In this embodiment, an execution body may be a terminal, or may be a server. The to-be-described image may be obtained by another terminal device to the image description system using wireless/wired communication. Alternatively, several images may be prestored in the image description system. The system may, without limitation, automatically extract the corresponding to-be-described image when a criteria is met (e.g., set time is reached). However, some embodiments are not limited to the aforementioned example. The to-be-described image includes an image on which image description needs to be performed. The image description system is a hardware device system for image description. For example, the image description system may be an electronic device, the electronic device may be a server, or a terminal, and the image description system may also be a system in which a server interacts with a terminal.

120: Obtain an image description model and a description prompt text, the description prompt text being configured for providing an image description rule for performing image description by the image description model.

The description prompt text is obtained by correcting an initial prompt text corresponding to the image description rule based on a first text difference between a sample image description text and a predicted image description text, the sample image description text is obtained based on a sample image and the image description rule, the predicted image description text is obtained by the image description model performing image description on the sample image, and the initial prompt text is initialized based on the image description rule. The image description rule is a condition that needs to be complied with when the image description text is generated, which may be preset or empirically derived through testing. The image description rule may include a boundary condition for generating the image description text, a reference condition for generating the image description text, or the like. For example, when image classification and description are performed, the image description rule may include a reference condition of an image category, a representation condition of an image category, or the like. For example, when a two-dimensional code image is classified and identified, the image description rule may be "a two-dimensional code appears in an image". For example, when image content is described, the image description rule may define a condition that needs to be complied with when generating a subject description text and a condition that needs to be complied with when generating a non-subject content description text. For example, when the image content is described, the image description rule may include "content with distinct characteristics among attributes, including facial features, expressions, hair, decorative accessories, clothing, shoes, socks, hats, postures, movements, makeup, and the like needs to be described in the subject content" and "content is simply summarized when no distinct features exist in the non-subject content". In some embodiments, the image description rule may further include a preset text format, a language format, and the like that need to be complied with when generating the image description text. The language format refers to how each part in the text is composed, and the text format refers to a specification or a standard of the text content, for example, a pure text format.

After the to-be-described image is obtained, a corresponding image description model may be determined based on the to-be-described image. For example, different to-be-described images are classified before being obtained. Some of the to-be-described images are classification tasks, and some of the to-be-described images are detection tasks. Alternatively, more task types such as image descriptions may exist. The system may select algorithms of different image description models based on task types of different images, to determine corresponding image description models. The image description model is configured to generate, based on an input image and the description prompt text, text describing content in the input image. The image description model may be a multi-modal language model. The multi-modal language model completes various multi-modal tasks through information in a plurality of modalities. The information in the plurality of modalities may be information in at least two modalities. The modality information includes, but is not limited to, text information, image information, video information, audio information, or the like. The sample image and the to-be-described image are usually images of the same task type, namely, an image description rule of the sample image is the same as that of the to-be-described image.

When the image description model is obtained, the description prompt text is further obtained. The description prompt text may be a question, a sentence, or a complete dialog context. The description prompt text can provide the image description rule for the image description model, so that the image description model can generate, based on the description prompt text, description text for the to-be-described image according to the image description rule.

FIG. 2b is a schematic diagram of an image description rule according to some embodiments. In a case that a to-be-described image generates a description text based on a rule in FIG. 2b, when content identified by the image description model for the image satisfies the description rule in FIG. 2b, the corresponding to-be-described image is described as a description label corresponding to the corresponding description rule. The description label is image description text of the to-be-described image. In other words, a task type of the to-be-described image is an image classification.

FIG. 2c is another schematic diagram of an image description rule according to some embodiments. When a to-be-described image generates a description text based on a rule in FIG. 2c, the image description model identifies the image, for example, obtains content of the to-be-described image through operations such as image feature extraction and image fusion, and generates a segment of description text based on the description rule of FIG. 2c. The task type is image description (different from image classification as illustrated in FIG. 2b).

FIG. 2b and FIG. 2c are merely two examples listed in some embodiments. Alternatively, more image description rules may exist, and the disclosure is not limited to the foregoing two examples.

Furthermore, in some embodiments, before the identification and description of the image is performed, multi-modal large language model (MLLM) prompt iteration is performed on the image description model, so as to obtain the process of the description prompt text. In other words, before the description prompt text is obtained, the following operations are performed:

performing initialization based on a preset image description rule, to obtain an initial prompt text;

inputting the initial prompt text and the sample image into the image description model, and performing image description on the sample image based on the initial prompt text through the image description model, to obtain a predicted image description text;

obtaining a sample image description text based on the image description rule and the sample image;

obtaining a first text difference based on the sample image description text and the predicted image description text; and

correcting the initial prompt text based on the first text difference, to obtain a description prompt text.

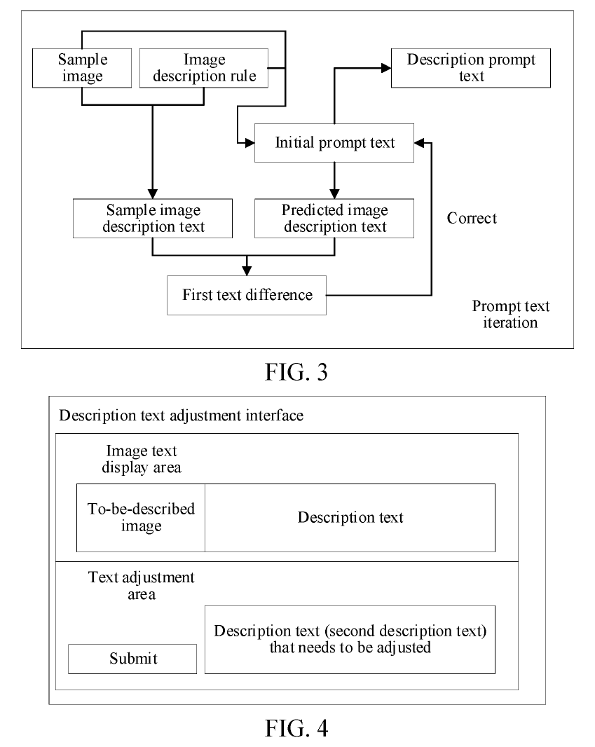

FIG. 3 is a schematic flowchart of iteration of an image description model according to some embodiments. Before a description prompt text is obtained, the description prompt text of the sample image is initialized based on a preset image description rule, to obtain an initial prompt text. The preset image description rule may be the example rules described in conjunction with in FIG. 2b and FIG. 2c, or may be another rule. The preset image description rule may be a rule transmitted to a system through another device, or may be a rule generated by the system based on setting. The initial prompt text may refer to an initial description prompt text generated based on the image description rule. The initial prompt text includes information about the image description rule. The image description model may extract the information about the image description rule from the initial prompt text and perform image description.

A process of initializing the description prompt text may be a prompt text of a to-be-described image generated by the system based on the image description rule, or may be a prompt text of a to-be-described image inputted into the system through another terminal device. In other words, an initial prompt text includes a corresponding image description rule, and the image description model may generate a description text corresponding to the to-be-described image based on the initial prompt text. The initial prompt text is a description prompt text having a relatively large error. The description text generated based on the initial prompt text may have a relatively large image description error.

After the initial prompt text is obtained, the initial prompt text and the sample image are inputted into the image description model. Image description is performed on the sample image based on the initial prompt text through the image description model, to obtain a predicted image description text. The sample image may be selected based on an actual situation, may be transmitted to the system by another terminal device, or may be extracted from a preset storage space in the system. After the sample image is obtained, the image description model may perform image description on the sample image based on the initial prompt text and the image description rule corresponding to the initial prompt text, to obtain the predicted image description text. The predicted image description text may include the sample image and the predicted description text corresponding to the sample image.

While obtaining the predicted image description text, a sample image description text (e.g., Gold Labels data) may further be obtained. The sample image description text is obtained based on the image description rule and the sample image. For example, the description text of the sample image may be generated based on the image description rule, or the description text of the sample image may be directly obtained. The description text may be preset based on the image description rule, or accurate sample image description text generated based on the image description text of the sample image is prestored in the system, and then may be directly read by the image description system. Alternatively, it may be transmitted and obtained by another terminal device. The sample image description text may be generated by another terminal device and obtained after manual correction, or may be obtained by manual direct input.

Then, a first text difference is obtained based on the sample image description text and the predicted image description text. This may include comparing the sample image description text with the predicted image description text, determining a difference point between the sample image description text and the predicted image description text (e.g., first text), correcting the initial prompt text according to the first text based on automatic modification by a system or base on an input by another terminal device, so that a question, a sentence, or a complete dialogue context in the initial prompt text is improved, and a finally obtained difference rate between the predicted image description text and the sample image description text is less than a preset value. Therefore, the corrected initial prompt text may refer to the description prompt text (e.g., prompt).

In other words, after the to-be-described image is obtained, the image description model may generate an image description text that meets a requirement based on the description prompt text, thereby improving accuracy of image description text generation.

130: Input the description prompt text and the to-be-described image into the image description model, and perform image description on the to-be-described image based on the description prompt text through the image description model, to obtain a first image description text that conforms to the image description rule.

After the description prompt text is obtained, the description prompt text and the to-be-described image are inputted to the image description model, and then the image description model performs image description on the to-be-described image based on the description prompt text, so as to obtain the first image description text that conforms to the image description rule. For example, for a task of image description, the first image description text may be generated based on the description rule of FIG. 2c. The first image description text refers to a text configured for describing content in the to-be-described image based on the image description rule, and may include the to-be-described image and the corresponding first description text. For example, the first description text may be "a man and a woman sit facing each other on the steps at night. The woman wears hair accessories with a white garment featuring blue sleeves, while the man sports a high ponytail, blue clothing, a black-gray vest, and grips a short sword. The scene is set outside towering steps of an ancient architectural structure", or "an elderly man glares furiously at a woman. The man, with disheveled silver-streaked hair, is draped in a dragon-embroidered imperial robe and collapses slumped on the floor, his face contorted with disbelief and rage. The woman, clad in cerulean robes and crowned with a phoenix-adorned headdress, stands facing him with her back turned to the viewer. The scene is set in a bedchamber of an emperor and is adjacent to the royal dais", or the like.

After the first image description text is obtained, the to-be-described image may be annotated. It may be learned from the above that the description prompt text that meets the description requirement is obtained through the sample image description text and the predicted image description text, and then the image description model may generate, based on the description prompt text, the first image description text that conforms to the image description rule without consuming network resources to identify information such as a candidate box and a classification of the image, and the first image description text can be directly generated, thereby avoiding a waste of the network resources and saving the network resources. In addition, the first image description text of the to-be-described image that conforms to the image description rule can be rapidly generated by using the description prompt text through the image description model. Then, the to-be-described image may be annotated through the first image description text, which can reduce complexity in an image annotating process, thereby improving image annotating efficiency.

Further, in some embodiments, FIG. 4 is a schematic diagram of a description text adjustment interface according to some embodiments. To further improve image description accuracy, after a first image description text is obtained, the first image description text may continue to be adjusted. Therefore, after the first image description text is obtained, the following operations may be performed:

displaying a description text adjustment interface, the description text adjustment interface including an image text display area and a text adjustment area, the image text display area being configured for displaying the first image description text;

adjusting the first image description text in the text adjustment area in response to a modification operation on a description text, to obtain a second image description text; and

updating the second image description text to the image text display area to replace the first image description text.

In this embodiment, an execution body may be a terminal, or may be a server. After the first image description text is obtained, the first image description text is displayed on the description text adjustment interface. The to-be-described image and the first description text in the first image description text may be displayed in the image text display area.

When the first image description text needs to be adjusted (e.g., when the first description text needs to be adjusted), in response to a modification operation on the description text, the first image description text is adjusted in the text adjustment area, to obtain the second image description text. The description text after the first description text is modified (e.g., the second description text), is entered in the text adjustment area, and then the first description text is replaced with the second description text.

Replacing the first description text may include selecting a submission button in the text adjustment area, so as to submit the second description text to the description text adjustment interface. In this case, content displayed in the image text display area is the to-be-described image and the second description text. In other words, the second image description text includes the to-be-described image and the second description text. The second description text can modify the content in the first description text more accurately, so that the obtained text can better conform to the image description rule.

When the second description text replaces the first description text, the second image description text is updated to the image text display area to replace the first image description text, so that more accurate image description text can be obtained, and annotated content can be more accurate when the to-be-described image is annotated.

Further, in some embodiments, after the updating the second image description text to the image text display area to replace the first image description text, the following operation may be performed:

adding the second image description text to the sample image description text, to update the sample image description text.

Because a quantity of the sample image description texts obtained in the foregoing solution may be relatively small, and the obtained first image description text has relatively low accuracy, a plurality of first image description texts obtained need to be corrected. Therefore, to improve accuracy of describing the image by the image description model, in this case, the server may add the second image description text to the sample image description text, to update the sample image description text. The second image description text may be used as the sample image description text, namely, comparison adjustment may be performed on the predicted image description text based on more sample image description texts, so that more accurate description prompt text can be obtained. A modification rate of the image description text generated through the image description model can be reduced, and accuracy of the generated image description text can be improved.

Further, in some embodiments, before the updating the second image description text to the image text display area to replace the first image description text, following operations may be performed:

obtaining a comparison text of the first image description text and the second image description text; and

performing the operation of updating the second image description text to the image text display area to replace the first image description text if the comparison text meets a preset text modification requirement.

Specifically, the description text adjustment interface may further include a comparison area. The comparison area may be a separate interface. Before the second description text is obtained to replace the first description text, the to-be-described image and the first description text and the second description text that correspond to the to-be-described image are displayed in the comparison area, and different points are displayed in the two texts. The different points may be displayed based on underscoring, or may be displayed in fonts of different colors, or may be displayed differently. The first description text and the second description text displayed with the different points are comparison texts of the first image description text and the second image description text.

Through the comparison texts, a related person may find the difference between the first image description text and the second image description text, may determine whether the first image description text is modified by the second image description text, and may find whether the modified text meets a preset text modification completion condition. The preset text modification completion condition refers to a condition when the modification of the first image description text is completed, and may include, but is not limited to, that the modified text (e.g., the second description text) meets the image description rule, that the second description text meets a word count requirement, and the like.

If the preset text modification completion condition is met, and it is proved that the second description text meets the requirement of the image description rule, modification on the first image description text is completed. In this case, the operation of updating the second image description text to the image text display area to replace the first image description text is performed, so that accuracy of the obtained image description text can be ensured as much as possible.

If the preset text modification completion condition is not met, the first image description text may continue to be modified in the text adjustment area until the obtained second image description text meets the preset text modification completion condition. The preset text modification completion condition may be set based on an actual situation, for example, whether a word count requirement is satisfied, or whether a paragraph requirement is satisfied.

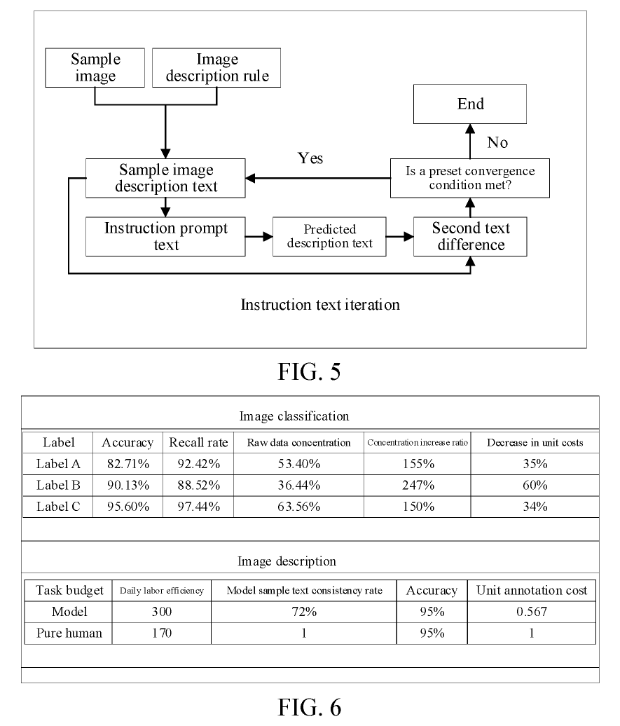

Further, in some embodiments, to further improve accuracy of generating the image description text by the image description model, FIG. 5 is another schematic flowchart of iteration of an image description model according to some embodiments. Before the inputting the description prompt text and the to-be-described image into the image description model, and performing image description on the to-be-described image based on the description prompt text through the image description model, to obtain a first image description text that conforms to the image description rule, the following operations may be performed:

obtaining an instruction prompt text based on the sample image description text, the instruction prompt text including an image description instruction and a sample description text corresponding to the image description instruction;

guiding, based on the image description instruction, the image description model to perform image description on a sample image, to obtain a predicted description text;

obtaining a second text difference based on the predicted description text and the sample description text;

performing parameter optimization and iteration on the image description model based on the second text difference and the instruction prompt text, until the second text difference meets a preset convergence condition; and

performing, if the second text difference meets the preset convergence condition, the operation of inputting the description prompt text into the image description model, and performing image description on the to-be-described image through the image description model, to obtain a first image description text that conforms to the image description rule.

In other words, before the first image description text is obtained, the image description model is iteratively trained. First, an instruction prompt text is obtained based on the sample image description text. Instruct Prompt data (instruction prompt text) may be constructed through Gold Labels data. The instruction prompt text includes an image description instruction and a sample description text corresponding to the image description instruction. The image description instruction is an instruction instructing the image description model to perform image description. The sample description text may be a text in the sample image description text. The instruction prompt text may be constructed based on the following.

Defining a task: A task or a problem that needs to be resolved is clarified, for example, image classification or image description.

Determining Gold Labels: Gold Labels are obtained through accurate and trusted labels or answers provided by manual annotation or experts. The Gold Labels are real standards or reference answers of tasks.

Design instruction (Instruct): A set of instructions (Instruct) are designed based on a requirement of a task and a feature of a sample, to instruct a model to generate a correct answer. The instruction is clear, concise, and easy to understand, and can guide the model to complete the task correctly.

Constructing a sample: The Gold Labels are paired with the corresponding input samples, to form a training sample. Each training sample includes an input text and corresponding Gold Labels, namely, includes an image description instruction and a sample description text. Different sample structures may be designed based on different tasks.

Expanded samples: Based on a requirement, a data set may be expanded by increasing diversity of samples. Different input variants may be used, noise is introduced, or an input is modified, to increase richness of a data set.

Dividing data: The constructed Instruct Prompt data set is divided into a training set, a verification set, and a test set. The training set is configured for training a model, the validation set is configured for adjusting a hyper-parameter and evaluating performance of the model, and the test set is configured for finally evaluating generalization capability of the model.

After the instruction prompt sample is obtained, the image description model may be guided through the image description instruction to perform image description on the sample image, to obtain the predicted description text, and then a second text difference is obtained based on the predicted description text and the sample description text. The second text difference may be obtained after the image description model performs analysis, and then parameter optimization and iteration are performed on the image description model based on the second text difference and the instruction prompt text, until the second text difference satisfies the preset convergence condition.

Obtaining the second text difference may be based on a loss function(e.g., a cross entropy loss, a mean square error). Then, parameter optimization may be performed through a gradient descent algorithm or a variant thereof. During parameter optimization, the hyper-parameter of the model is optimized. The hyper-parameter includes a learning rate, a batch size, a regularization parameter, and the like. The effect of different hyper-parameter settings may be evaluated through cross validation or a validation set, and an optimal hyper-parameter combination is selected. The foregoing is merely an example. Alternatively, different algorithms may be selected based on different needs to perform parameter optimization and iteration.

The second text difference meeting the preset convergence condition may include a difference rate of the second text difference being less than a preset difference rate, or a number of iterative optimizations meeting a preset quantity of times. Further, after the sample description image is updated through the second image description text, the instruction prompt text may still be obtained through an updated sample description image, so that the foregoing iteration can be continuously repeated until the second text difference meets the preset convergence condition, (e.g., the accuracy of the generated predicted description text reaches the preset accuracy).

When the second text difference meets the preset convergence condition, the operation of inputting the description prompt text into the image description model and performing image description on the to-be-described image through the image description model, to obtain a first image description text that conforms to the image description rule. Therefore, in the foregoing method, the image description model can be further trained, so that the accuracy of generating the image description text by the image description model is improved, and operating efficiency in the image annotation process is improved.

Further, in some embodiments, the to-be-described image includes at least two to-be-described images, and the inputting the description prompt text and the to-be-described image into the image description model, and performing image description on the to-be-described image based on the description prompt text through the image description model, to obtain a first image description text that conforms to the image description rule includes:

performing feature extraction on the at least two to-be-described images through the image description model, to obtain image labels respectively corresponding to the at least two to-be-described images;

inputting the description prompt text into the image description model, and obtaining a screening label based on the image description rule;

screening the at least two to-be-described images based on the screening label and the image label, to obtain a to-be-described image associated with the image description rule and a target image; and

performing image description on the target image through the image description model, to obtain the first image description text that conforms to the image description rule.

Because many to-be-described images exist, and types of the images are also different, before image description is performed on a plurality of to-be-described images, the images further need to be screened and classified, so as to screen to-be-described images that do not conform to the image description rule. For example, the image description rule is an image animal classification description rule. When the plurality of to-be-described images include images that do not include an animal, the images that do not include an animal need to be screened out.

Feature extraction may be performed on the to-be-described image through the image description model, to obtain an image label. For example, the image description model may use a convolutional neural network to extract representative feature vectors from the to-be-described image. These feature vectors may capture information such as a shape, texture, and color of the image, and then add a descriptive text label (e.g., the image label), to the image based on automatic annotation. The image label is configured to represent a task type corresponding to the to-be-described image, such as an image classification task or an image description task.

Then, the description prompt text is inputted into the image description model, and a screening label is obtained based on the image description rule. The screening label is configured to represent a task type corresponding to the image description rule represented by the description prompt text. The task type of a to-be-described image that needs to be screened may be determined based on the description prompt text. For example, whether the to-be-described image is image classification or image description may be determined based on the description prompt text. If the to-be-described image is image classification, a label for image classification may be obtained through the description prompt text. For example, if the description prompt text is a question, and may be "whether the image is a two-dimensional code", the label may be a two-dimensional code classification task, namely, the screening label.

Then, each to-be-described image is screened based on the screening label and the image label, to obtain a to-be-described image associated with the image description rule, to obtain the target image. In other words, a to-be-described image with an image label the same as that of the screening label is reserved, so that the to-be-described image corresponding to the image description rule of the screening label can be obtained and configured as the target image.

Finally, image description is performed on the target image through the image description model, to obtain a first image description text that conforms to the image description rule. In other words, images corresponding to the description prompt text can be pre-screened, to reserve an image that meets the requirement and to screen out the to-be-described images unassociated with the screening label. In this way, the image can be screened before image description is performed on the to-be-described image through the image description model, so as to better perform image description, avoiding identification of the to-be-described images of a task type different from that of the image description rule, thereby improving accuracy of image description on the to-be-described image.

To facilitate image selection, further, in some embodiments, the target image includes at least two target images, and the performing image description on the target image through the image description model, to obtain the first image description text that conforms to the image description rule includes:

obtaining image labels of at least two target images;

dividing the at least two target images based on the image labels, to obtain target images with the same label; and

performing image description on the target images with the same label through the image description model, to obtain the first image description text that conforms to the image description rule.

When the first image description text is obtained based on the target image, an image label of the target image is first obtained, and is used as a classification image label. Classification is performed based on the classification image label, to obtain classified images. For example, classification image labels of different target images may be two-dimensional codes, disturbing content, ostentatious display of wealth, historical costumes, and the like. The target images may be classified through these labels, namely, target images including two-dimensional code labels are classified together, and target images including disturbing content labels are classified together, to obtain the classified images.

Finally, image description is performed on the classified images through the image description model, to obtain the first image description text of the target image that conforms to the image description rule, so that the image description model can perform image description on the target image, and can better classify and describe the target image. In other words, the image description may be first performed on target images with the same label, to improve order of the image description, thereby improving quality of the image description.

Further, in some embodiments, the performing image description on the target image through the image description model, to obtain the first image description text that conforms to the image description rule includes:

obtaining text labels of a plurality of description prompt texts;

determining, from the text labels of the plurality of description prompt texts, a text label that matches an image label corresponding to the target image, to obtain a target label;

obtaining a description prompt text corresponding to the target label from the plurality of description prompt texts, to obtain a target prompt text; and

performing image description on the target image through the image description model, to obtain the first image description text that conforms to the image description rule corresponding to the target prompt text.

Specifically, during image description, different description prompt texts need to be selected for different image tasks. In other words, different image description rules correspond to different description prompt text, and a text label for the description prompt text exists. For example, if the image description rule is generating the image description text, the corresponding description prompt text label may be description. If the image description rule is image classification, the corresponding description prompt text label may be classification. An actual text label may be set based on an actual situation.

While the image label can classify the target image, task classification can be performed on the target image, that is, whether the target image performs an image description task or an image classification task, or another task is determined. For example, two-dimensional code labels and labels indicating disturbing content and ostentatious displays of wealth may be selected as an image classification task, and historical costume labels may be selected as an image description task. Therefore, a text label of each description prompt text may be obtained, and then the text label of each description prompt text is matched and corresponded with the image label of each target image, to determine the task that the target image needs to perform.

Therefore, after the target label is obtained, the description prompt text corresponding to the target label may be obtained from the description prompt texts, and is used as the target prompt text. Finally, the image description is performed on the classified image through the image description model, to obtain the first image description text that conforms to the image description rule corresponding to the target prompt text. Further, for different types of images, different description prompt texts may be selected for image description, thereby improving the accuracy of the image description.

Further, in some embodiments, the same target label corresponds to at least two description prompt texts, and the obtaining a description prompt text corresponding to the target label, to obtain a target prompt text includes:

obtaining a text call rate of the plurality of description prompt texts corresponding to the target label within a preset time period; and

using, as the target prompt text, the description prompt text corresponding to a maximum text call rate.

When the target prompt text is obtained, a plurality of description prompt texts for a same target label may exist, i.e. different image description rules are set. For example, for a task of image description, a situation in which the image description rule only describes the people in the image exists, a situation in which both the people and the scenery are described also exists, and a situation in which only the scenery is described may even exist. Therefore, the image description rule needs to be selected, namely, the description prompt text is selected.

The selection may include obtaining a text call rate of each description prompt text corresponding to the target label within a preset time period (e.g., a quantity of use times of the description prompt text corresponding to the target label within one time period), and using a description prompt text corresponding to a maximum quantity of use times (e.g., a maximum text call rate, as the target prompt text), so as to provide an image description rule for the image description model based on the target prompt text, to perform an image description task, thereby obtaining image description text that meets a requirement.

Selection of the description prompt text through the text call rate may have a relatively large selection error. Therefore, selection may also be performed differently. Further, in some embodiments, the same target label corresponds to at least two description prompt texts, and the obtaining a description prompt text corresponding to the target label, to obtain a target prompt text further includes:

determining whether the image labels respectively corresponding to the at least two target images include any prohibited label;

obtaining, if the prohibited label exists, target labels corresponding to the image labels including the prohibited label, to obtain target screening labels;

obtaining description prompt texts corresponding to the target screening labels, to obtain screening prompt texts; and

obtaining, based on the screening prompt texts, a description prompt text remaining in the at least two description prompt texts corresponding to the target labels, to obtain the target prompt text.

Specifically, whether the image label of the target image includes the prohibited label is first determined. The prohibited label may be preset based on an actual circumstances. For example, the prohibited label may be a luxury vehicle or a sensitive area. These labels may be obtained through image identification.

If the prohibited label exists, the target label corresponding to the image label for which the prohibited label exists is obtained and used as the target screening label. For example, if the prohibited label exists, the image description rule that only describes the people in the image is selected, and the image description rule that describes the scenery exists. In other words, the description prompt text that describes the scenery is the screening prompt text, and the description prompt text that does not describe the scenery is the target prompt text. After the screening prompt text is excluded from the description prompt texts, the remaining description prompt text is the target prompt text.

As the description prompt text can be better selected, the obtained description prompt text can better meet the requirement of the target description, the obtained image description text is more accurate, and the number of times of manual modification can be reduced as much as possible. As a result, those reduce workload of staff and improve operating efficiency in the image annotation process.

FIG. 6 is a schematic diagram of a comparison of efficiency between manual image description and image description through an image description model according to some embodiments. FIG. 6 includes tasks of image classification and image description, and presents an improvement index for an annotation task during image description performed by an image description model and an annotation process. In a scenario of a task of image classification, for a label A, a label B, and a label C, after screening is performed through an MLLM, a concentration of annotated data greatly increases, reaching 155%, 247%, and 150% respectively, and a unit annotation cost is also reduced by 25%, 60%, and 34% respectively.

In an image description task, a first image description text is generated through the image description model, and then the first image description text is manually modified based on the first image description text. A quantity of annotations per person day increases from 170 to 300. A consistency rate of a text generated through the image description model and a final text manually reaches 72%. Final accuracy does not significantly change, and a unit annotation cost is reduced from 1 to 0.567, which saves a lot of annotation costs for a service.

In some embodiments, the following operations may be performed to achieve such improvements in computer technology or technical field: obtaining a to-be-described image; obtaining an image description model and a description prompt text, the description prompt text being configured for providing an image description rule for performing image description by the image description model; and inputting the description prompt text and the to-be-described image into the image description model, and performing image description on the to-be-described image based on the description prompt text through the image description model, to obtain a first image description text that conforms to an image description rule, the description prompt text being obtained by correcting an initial prompt text corresponding to the image description rule based on a first text difference between a sample image description text and a predicted image description text, the sample image description text being obtained based on a sample image and the image description rule, the predicted image description text being obtained by the image description model performing image description on the sample image based on the initial prompt text, and the initial prompt text being initialized based on the image description rule. According to some embodiments, the description prompt text that meets the description requirement is obtained through the sample image description text and the predicted image description text, and then the image description model may generate, based on the description prompt text, the first image description text that conforms to the image description rule without consuming network resources to identify information such as a candidate box and a classification of the image, and the first image description text can be directly generated, thereby avoiding a waste of the network resources and saving the network resources. In addition, the first image description text of the to-be-described image that conforms to the image description rule can be rapidly generated by using the description prompt text through the image description model. Then, the to-be-described image may be annotated through the first image description text, which can reduce complexity in an image annotating process, thereby improving image annotating efficiency.

According to the method described in the foregoing embodiment, a detailed description is further provided below by using an example in which the image description apparatus is integrated in a terminal.

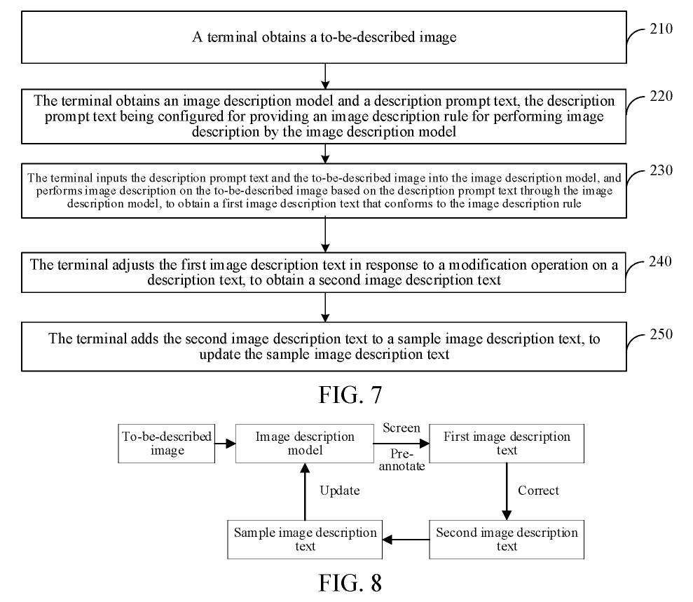

Some embodiments provide an image description method. As shown in FIG. 7, the image description method may include the following specific operations.

210: A terminal obtains a to-be-described image.

The to-be-described image is obtained by another terminal device to the image description system using wired/wireless communication. Alternatively, several images may be prestored in the image description system. The system may automatically extract the corresponding to-be-described image when a criteria is met (e.g., set time is reached). However, some embodiments are not limited to the aforementioned examples.

220. The terminal obtains an image description model and a description prompt text, the description prompt text being configured for providing an image description rule for performing image description by the image description model.

The description prompt text is obtained by correcting an initial prompt text corresponding to the image description rule based on a first text difference between a sample image description text and a predicted image description text, the sample image description text is obtained based on a sample image and the image description rule, the predicted image description text is obtained by the image description model performing image description on the sample image, and the initial prompt text is initialized based on the image description rule.

230: The terminal inputs the description prompt text and the to-be-described image into the image description model, and performs image description on the to-be-described image based on the description prompt text through the image description model, to obtain a first image description text that conforms to the image description rule.

240: The terminal adjusts the first image description text in response to a modification operation on a description text, to obtain a second image description text.

250: The terminal adds the second image description text to a sample image description text, to update the sample image description text.

FIG. 8 is a schematic data flowchart of image description according to some embodiments. After a terminal obtains a to-be-described image, an image description model first performs classification and screening on the to-be-described image, so as to obtain a classified image. Then, the terminal pre-annotates, based on the corresponding description prompt text, the classified image through the image description model, namely, obtains a first image description text. The first image description text may then be corrected to obtain an accurate second image description text.

Then, the terminal adds the second image description text to the sample image description text, and updates the sample image description text, to implement update and iteration of the image description model, so that the image description model can perform image description more accurately, thereby improving accuracy of the image description.

As such, the following operations may be performed: obtaining, by the terminal, a to-be-described image; obtaining an image description model and a description prompt text, the description prompt text being configured for providing an image description rule for performing image description by the image description model; and inputting the description prompt text and the to-be-described image into the image description model, and performing image description on the to-be-described image through the image description model based on the description prompt text, to obtain a first image description text that conforms to an image description rule the description prompt text being obtained by correcting an initial prompt text corresponding to the image description rule based on a first text difference between a sample image description text and a predicted image description text, the sample image description text being obtained based on a sample image and the image description rule, the predicted image description text being obtained by the image description model performing image description on the sample image based on the initial prompt text, and the initial prompt text being initialized based on the image description rule. According to some embodiments, the description prompt text that meets the description requirement is obtained through the sample image description text and the predicted image description text, and then the image description model may generate, based on the description prompt text, the first image description text that conforms to the image description rule without consuming network resources to identify information such as a candidate box and a classification of the image, and the first image description text can be directly generated, thereby avoiding a waste of the network resources and saving the network resources. In addition, the first image description text of the to-be-described image that conforms to the image description rule can be rapidly generated by using the description prompt text through the image description model. Then, the to-be-described image may be annotated through the first image description text, which can reduce complexity in an image annotating process, thereby improving image annotating efficiency.

In some embodiments, an image description method is provided. The image description method may be performed by a computer device, and may include the following operations. The operations may be performed sequentially, in a different order, in parallel, or with some operations skipped or repeated.

1. Perform initialization based on a preset image description rule, to obtain the initial prompt text; input the initial prompt text and the sample image into the image description model; and perform image description on the sample image based on the initial prompt text through the image description model, to obtain a predicted image description text.

2. Obtain a sample image description text based on the image description rule and the sample image; obtain a first text difference based on the sample image description text and the predicted image description text; and correct the initial prompt text based on the first text difference, to obtain a description prompt text.

3. Obtain a to-be-described image, and obtain an image description model and a description prompt text, the description prompt text being configured for providing an image description rule for performing image description by the image description model.

4. Obtain an instruction prompt text based on the sample image description text, the instruction prompt text including an image description instruction and a sample description text corresponding to the image description instruction; and guide, based on the image description instruction, the image description model to perform image description on a sample image, to obtain a predicted description text.

5. Obtain a second text difference based on the predicted description text and the sample description text; and perform parameter optimization and iteration on the image description model based on the second text difference and the instruction prompt text, until the second text difference meets a preset convergence condition.

6. Input the description prompt text and the to-be-described image into the image description model if the second text difference meets a preset convergence condition, and perform feature extraction on the at least two to-be-described images through the image description model, to obtain image labels respectively corresponding to the at least two to-be-described images.

7. Input the description prompt text into the image description model, and obtain a screening label based on the image description rule; and screen the at least two to-be-described images based on the screening label and the image labels, to obtain a to-be-described image associated with the image description rule, and a target image.

8. Perform image description on the target image through the image description model, to obtain the first image description text that conforms to the image description rule.

9. Display a description text adjustment interface, the description text adjustment interface including an image text display area and a text adjustment area, the image text display area being configured for displaying the first image description text; and adjust the first image description text in the text adjustment area in response to a modification operation on a description text, to obtain a second image description text.

10. Obtain a comparison text of the first image description text and the second image description text; and update the second image description text to the image text display area to replace the first image description text if the comparison text meets a preset text modification completion condition, and add the second image description text to the sample image description text, to update the sample image description text.

The description prompt text that meets the description requirement is obtained through the sample image description text and the predicted image description text, and then the image description model may generate, based on the description prompt text, the first image description text that conforms to the image description rule without consuming network resources to identify information such as a candidate box and a classification of the image, and the first image description text can be directly generated, thereby avoiding a waste of the network resources and saving the network resources. In addition, the first image description text of the to-be-described image that conforms to the image description rule can be rapidly generated by using the description prompt text through the image description model. Then, the to-be-described image may be annotated through the first image description text, which can reduce complexity in an image annotating process, thereby improving image annotating efficiency.

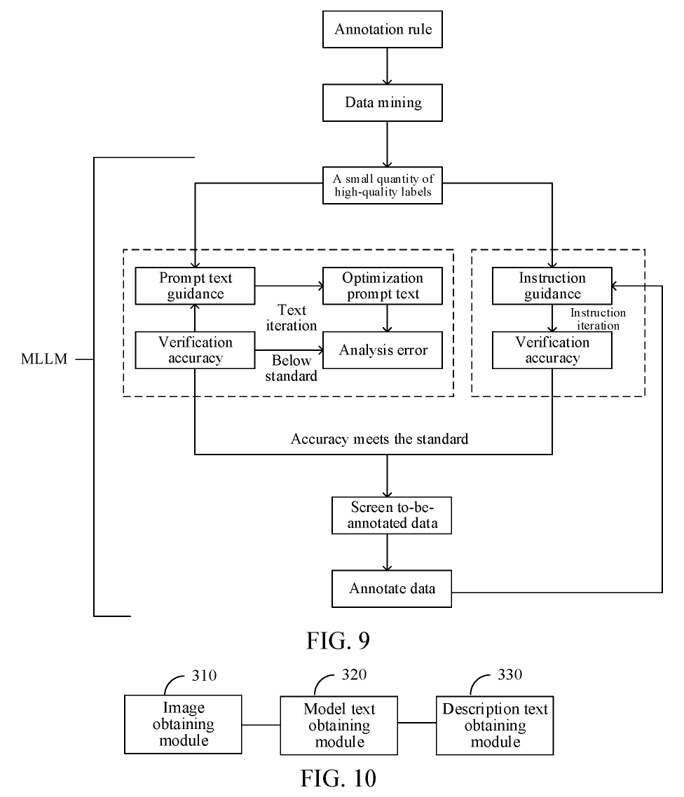

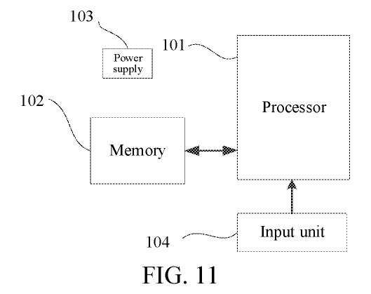

In some embodiment, as shown in FIG. 9, a schematic flowchart of establishing an image description model is provided. The image description model is a large language model (e.g., multi-modal language model). Specifically, an annotation rule is obtained. The annotation rule is an image description rule, and may be, for example, the description rules defined in FIG. 2b and FIG. 2c. Then, data mining is performed to obtain sample data trained by the model. Next, high-quality sample data manually annotated by an expert may be obtained. The sample data includes a sample image and a sample image description text. Then, the sample data is configured for performing prompt text iteration. In other words, the sample data is configured for training a multi-modal language model. A difference between a model prediction result and a sample image description text annotated by an expert is determined, and model prediction accuracy is calculated. When the model prediction accuracy does not reach a standard, an incorrect sample is analyzed, the prompt text is optimized and corrected, and repeated iteration is continuously performed, until preset accuracy is reached, to obtain a multimodal language model that is completely trained. Then, instruction text iteration may be performed on the model on which training is completed, to further improve prediction accuracy of the model. In an instruction text iteration process, VisualGLM-6B may be used as a base model. A model architecture of the VisualGLM-6B mainly includes three modules: ViT, QFormer, and ChatGLM-6B. During training, almost all parameters of the ViT and the ChatGLM are frozen, to prevent catastrophic forgetting. During iteration, LoRA adapters of the QFormer and the ChatGLM are fine-tuned. Loss used during training includes two parts: an autoregressive loss and a contrastive loss, and training data uses a sample corresponding to an annotation task. Finally, to-be-annotated data may be obtained through the trained multi-modal language model, and then to-be-annotated samples are screened, to filter out invalid negative samples in the to-be-annotated samples. Then, prediction is performed on the to-be-annotated sample through the trained model, to generate an annotation description text. The generated annotation description text may be further adjusted, to obtain an annotation text corresponding to a final sample. In other words, the trained multi-modal language model is annotated and generated, thereby improving efficiency and accuracy of generating an annotation text.

In a specific embodiment, the image description method is applied to an annotation scenario of image classification. Specifically, when a server needs to train an image classification model, images whose categories are annotated need to be used. In this case, the server may obtain a to-be-annotated image and a description prompt text. The description prompt text is configured for a classification description rule. For example, the description prompt text may be "does a human face exists in the image". The server inputs the to-be-annotated image and the image description text into the image description model, and performs image description on the to-be-annotated image based on the image description prompt text through the image description model, to obtain an image description text. The image description text may be "a human face exists in the image". In this case, the server may generate, based on the image description text, a label indicating whether a human face in the to-be-annotated image, for example, "the to-be-annotated image is a label indicating that the human face exists in the image". The server may generate labels indicating whether a large quantity of human faces corresponding to the to-be-annotated image exist through the image description model. Then, an image classification model that identifies whether the human face exists may be trained through a large quantity of annotated images and a label indicating whether the human face exists, to obtain the image classification model. Whether the human face exists in the image may be identified through the image classification model. In other words, the annotation text corresponding to the to-be-annotated image may can directly generated through the image description model, thereby improving efficiency and accuracy of generating the annotation text.

To perform the operations described herein, some embodiments further provide an image description apparatus. As shown in FIG. 10, the image description apparatus may include an image obtaining module 310, a model text obtaining module 320, and a description text obtaining module 330. Unless explicitly stated otherwise, modules may refer to at least one of hardware (e.g., circuitry, central processing unit (CPU), graphics processing unit (GPU) or software (e.g., program, instructions) to perform various operations described herein.

The image obtaining module 310 is configured to obtain a to-be-described image.

A model text obtaining module 320 is configured to obtain an image description model and a description prompt text, the description prompt text being configured for providing an image description rule for performing image description by the image description model.

The description prompt text is obtained by correcting an initial prompt text corresponding to the image description rule based on a first text difference between a sample image description text and a predicted image description text, the sample image description text is obtained based on a sample image and the image description rule, the predicted image description text is obtained by the image description model performing image description on the sample image, and the initial prompt text is initialized based on the image description rule.

The description text obtaining module 330 is configured to input the description prompt text and the to-be-described image into the image description model, and perform image description on the to-be-described image based on the description prompt text through the image description model, to obtain a first image description text that conforms to the image description rule.

As such, the image obtaining module is configured to obtain the to-be-described image. Then, the model text obtaining module is configured to the image description model and the description prompt text, the description prompt text being configured for providing an image description rule for performing image description by the image description model. Next, the description text obtaining module is configured to input the description prompt text and the to-be-described image into the image description model, and perform image description on the to-be-described image based on the description prompt text through the image description model, to obtain a first image description text that conforms to an image description rule, the description prompt text being obtained by correcting an initial prompt text corresponding to the image description rule based on a first text difference between a sample image description text and a predicted image description text, the sample image description text being obtained based on a sample image and the image description rule, the predicted image description text being obtained by the image description model performing image description on the sample image based on the initial prompt text, and the initial prompt text being initialized based on the image description rule. According to some embodiments, the description prompt text that meets the description requirement is obtained through the sample image description text and the predicted image description text, and then the image description model may generate, based on the description prompt text, the first image description text that conforms to the image description rule without consuming network resources to identify information such as a candidate box and a classification of the image, and the first image description text can be directly generated, thereby avoiding a waste of the network resources and saving the network resources. In addition, the first image description text of the to-be-described image that conforms to the image description rule can be rapidly generated by using the description prompt text through the image description model. Then, the to-be-described image may be annotated through the first image description text, which can reduce complexity in an image annotating process, thereby improving image annotating efficiency.

Some embodiment further provide an electronic device. FIG. 10 is a schematic diagram of a structure of an electronic device according to some embodiments. The electronic device may be a terminal or a server. Specifically,

the electronic device may include components such as a processor 101 of one or more processing cores, a memory 102 of one or more computer-readable storage media, a power supply 103, and an input unit 104. A person skilled in the art may understand that a structure of the electronic device shown in FIG. 10 does not constitute a limitation on the electronic device, and the electronic device may include more or fewer components than those shown in the figure, or some merged components, or different component arrangements.

The processor 101 is a control center of the electronic device, is connected to all parts of the entire electronic device through various interfaces and lines, and implements various functions of the electronic device and performs data processing by running or executing a software program and/or a module stored in the memory 102 and calling data stored in the memory 102. The processor 101 may include one or more processing cores. The processor 101 may integrate an application processor and a modem processor. The application processor mainly processes an operating system, a user interface, an application program, and the like. The modem processor mainly processes wireless communication. The foregoing modem processor may not be integrated into the processor 101.

The memory 102 may be configured to store a software program and a module. The processor 101 executes various function applications and performs data processing by running the software program and the module stored in the memory 102. The memory 102 may mainly include a program storage area and a data storage area. The program storage area may have an operating system, an application program required by at least one function (such as a sound playback function and an image display function), and the like stored therein. The data storage area may have data and the like created based on use of the electronic device stored therein. In addition, the memory 102 may include a high-speed random access memory, and may further include a non-volatile memory, such as at least one magnetic disk storage device, a flash memory, or another volatile solid-state storage device. Correspondingly, the memory 102 may further include a memory controller, to provide access to the memory 102 for the processor 101.

The electronic device further includes a power supply 103 that supplies power to various components. The power supply 103 may be logically connected to the processor 101 through a power management system, so that functions such as charging, discharging, and power management may be achieved through the power management system. The power supply 103 may further include any component such as one or more direct current or alternating current power supplies, a recharging system, a power failure detection circuit, a power converter or inverter, a power status indicator, and the like.

The electronic device may further include an input unit 104. The input unit 104 may be configured to receive information about an inputted number or character, and generate inputs of a keyboard, a mouse, a joystick, an optical or trackball signal that are related to user settings and function control.

Although not shown, the electronic device may further include a display unit and the like. Details are not described herein again. Specifically, in this embodiment, the processor 101 in the electronic device loads executable files corresponding to processes of the one or more application programs to the memory 102 based on the following instructions, and the processor 101 runs the application programs stored in the memory 102, to implement the following functions:

obtaining a to-be-described image; obtaining an image description model and a description prompt text, the description prompt text being configured for providing an image description rule for performing image description by the image description model; and inputting the description prompt text and the to-be-described image into the image description model, and performing image description on the to-be-described image based on the description prompt text through the image description model, to obtain a first image description text that conforms to an image description rule, the description prompt text being obtained by correcting an initial prompt text corresponding to the image description rule based on a first text difference between a sample image description text and a predicted image description text, the sample image description text being obtained based on a sample image and the image description rule, the predicted image description text being obtained by the image description model performing image description on the sample image based on the initial prompt text, and the initial prompt text being initialized based on the image description rule.

For specific implementations of the above operations, reference is made to the foregoing embodiments. Details are not described herein again.

It can be learned from the above that in this embodiment, the following operations may be performed: obtaining a to-be-described image; obtaining an image description model and a description prompt text, the description prompt text being configured for providing an image description rule for performing image description by the image description model; and inputting the description prompt text and the to-be-described image into the image description model, and performing image description on the to-be-described image based on the description prompt text through the image description model, to obtain a first image description text that conforms to an image description rule, the description prompt text being obtained by correcting an initial prompt text corresponding to the image description rule based on a first text difference between a sample image description text and a predicted image description text, the sample image description text being obtained based on a sample image and the image description rule, the predicted image description text being obtained by the image description model performing image description on the sample image based on the initial prompt text, and the initial prompt text being initialized based on the image description rule. According to some embodiments, the description prompt text that meets the description requirement is obtained through the sample image description text and the predicted image description text, and then the image description model may generate, based on the description prompt text, the first image description text that conforms to the image description rule without consuming network resources to identify information such as a candidate box and a classification of the image, and the first image description text can be directly generated, thereby avoiding a waste of the network resources and saving the network resources. In addition, the first image description text of the to-be-described image that conforms to the image description rule can be rapidly generated by using the description prompt text through the image description model. Then, the to-be-described image may be annotated through the first image description text, which can reduce complexity in an image annotating process, thereby improving image annotating efficiency.

A person skilled in the art may understand that, all or some operations of various methods in the foregoing embodiments may be implemented through instructions, or implemented through instructions controlling relevant hardware, and the instructions may be stored in a computer-readable storage medium and loaded and executed by a processor.

For this purpose, some embodiments provide a computer-readable storage medium, having a plurality of instructions stored therein, and the instructions being loaded by a processor, to perform operations in any one of the image description methods provided in some embodiments. For example, the instructions may perform the following operations:

displaying a parameterized image annotation interface, the image annotation interface including a parameter configuration area, the parameter configuration area including a modular model component, the model component including a preset configuration and a modifiable parameter, and the modifiable parameter being configured for modifying the component code of the model component; obtaining, in response to a configuration operation on the model component, the model component corresponding to the component code based on the modifiable parameter, and using the model component as a first configuration model component; and building a first target model in a preset model building area based on the first configuration model component.

For specific implementations of the above operations, reference is made to the foregoing embodiments. Details are not described herein again.

The computer-readable storage medium may include a read-only memory (ROM), a random access memory (RAM), a magnetic disk, an optical disc, or the like.

Since the instructions stored in the computer-readable storage medium may perform operations in any one of the image description methods provided in some embodiments, the instructions can implement beneficial effects that can be achieved by any one of the image description methods provided in some embodiments. For details, reference is made to the foregoing embodiments. Details are not described herein again.

According to an aspect of the disclosure, a computer program product or a computer program is provided, the computer program product or the computer program including a computer instruction, the computer instruction being stored in a computer-readable storage medium. A processor of a computer device reads the computer instructions from the computer-readable storage medium. The processor executes the computer instructions, to cause the computer device to implement the method provided in the exemplary implementations of the above content sorting aspect.

The image description method and the related device provided in some embodiments are described above in detail. Although the principles and implementations of the disclosure are described through specific examples in the disclosure, the descriptions of the foregoing embodiments are merely intended to help understand the method and the core idea of the method of the disclosure. Meanwhile, a person skilled in the art may make modifications to the specific implementations and an application range according to the idea of the disclosure. In conclusion, the content of the disclosure is not to be construed as a limitation on the disclosure.

What is claimed is:

1. An image description method, comprising:
obtaining an image;
obtaining an image description model and a description prompt text, the description prompt text indicating an image description rule for performing image description by the image description model;
inputting the description prompt text and the image into the image description model; and
performing image description on the image based on the description prompt text through the image description model, to obtain a first image description text that conforms to the image description rule,
wherein the description prompt text is obtained by correcting an initial prompt text corresponding to the image description rule based on a first text difference between a sample image description text and a predicted image description text,
wherein the sample image description text is obtained based on a sample image and the image description rule,
wherein the predicted image description text is obtained by the image description model performing image description on the sample image based on the initial prompt text, and
wherein the initial prompt text is initialized based on the image description rule.

2. The image description method according to claim 1, wherein before the obtaining a description prompt text, the method further comprises:
performing initialization based on a preset image description rule, to obtain the initial prompt text;
inputting the initial prompt text and the sample image into the image description model;
performing image description on the sample image based on the initial prompt text through the image description model, to obtain a predicted image description text;
obtaining the sample image description text based on the image description rule and the sample image;
obtaining the first text difference based on the sample image description text and the predicted image description text; and
correcting the initial prompt text based on the first text difference, to obtain the description prompt text.

3. The image description method according to claim 1, wherein after the first image description text is obtained, the method further comprises:
displaying a description text adjustment interface including an image text display area and a text adjustment area, the image text display area being configured for displaying the first image description text;
adjusting the first image description text in the text adjustment area based on a modification operation on the first image description text, to obtain a second image description text; and
updating the image text display area to replace the first image description text with the second image description text.

4. The image description method according to claim 3, wherein after the updating the second image description text to the image text display area to replace the first image description text, the method further comprises:
adding the second image description text to the sample image description text, to update the sample image description text.

5. The image description method according to claim 3, wherein before the updating the second image description text to the image text display area to replace the first image description text, the method further comprises:
obtaining a comparison text of the first image description text and the second image description text; and
updating the image text display area to replace the first image description text to the second image description text based on the comparison text meeting a preset text modification completion condition.

6. The image description method according to claim 1, wherein before the inputting the description prompt text and the image into the image description model, the method further comprises:
obtaining an instruction prompt text based on the sample image description text, the instruction prompt text including an image description instruction and sample description text corresponding to the image description instruction;
guiding, based on the image description instruction, the image description model to perform image description on a sample image, to obtain a predicted description text;
obtaining a second text difference based on the predicted description text and the sample description text;
performing parameter optimization and iteration on the image description model based on the second text difference and the instruction prompt text, until the second text difference meets a preset convergence condition;
inputting, based on the second text difference meeting the preset convergence condition, the description prompt text into the image description model; and
performing image description on the image through the image description model, to obtain the first image description text that conforms to the image description rule.

7. The image description method according to claim 1, wherein the image includes at least two images, and
wherein the performing of the image description on the image comprises:
performing feature extraction on the at least two images through the image description model, to obtain image labels corresponding to each of the at least two images;
inputting the description prompt text into the image description model;
obtaining a screening label based on the image description rule;
screening the at least two images based on the screening label and the image labels, to obtain another image associated with the image description rule, and a target image; and
performing image description on the target image through the image description model, to obtain the first image description text that conforms to the image description rule.

8. The image description method according to claim 7 wherein the target image includes at least two target images, and
wherein the performing of the image description on the target image comprises:
obtaining image labels corresponding to each of the at least two target images;
dividing the at least two target images based on the image labels, to obtain target images with the same label; and
performing image description on the target images with the same label through the image description model, to obtain the first image description text that conforms to the image description rule.

9. The image description method according to claim 8, wherein the performing of image description on the target images with the same label through the image description model comprises:
obtaining text labels of a plurality of description prompt texts;
determining, from the text labels of the plurality of description prompt texts, a text label that matches an image label corresponding to the target image, to obtain a target label;
obtaining a description prompt text corresponding to the target label from the plurality of description prompt texts, to obtain a target prompt text; and
performing image description on the target images with the same label through the image description model, to obtain the first image description text that conforms to the image description rule corresponding to the target prompt text.

10. The image description method according to claim 9, wherein the same target label corresponds to at least two description prompt texts, and
wherein the obtaining of the description prompt text corresponding to the target label comprises:
obtaining a text call rate of the plurality of description prompt texts corresponding to the target label within a preset time period; and
using, as the target prompt text, the description prompt text corresponding to a maximum text call rate.

11. The image description method according to claim 10, wherein the same target label corresponds to the at least two description prompt texts, and
wherein the obtaining of the description prompt text corresponding to the target label further comprises:
determining whether the image labels corresponding to each of the at least two target images include any prohibited label;
obtaining, when the prohibited label exists, target labels corresponding to the image labels including the prohibited label, to obtain target screening labels;
obtaining description prompt texts corresponding to the target screening labels, to obtain screening prompt texts; and
obtaining, based on the screening prompt texts, a description prompt text remaining in the at least two description prompt texts corresponding to the target labels, to obtain the target prompt text.

12. An image description apparatus, comprising:
at least one memory configured to store computer program code; and
at least one processor configured to read the program code and operate as instructed by the program code, the program code comprising:
first obtaining code figured to cause the at least one of the at least one processor to obtain an image;
second obtaining code configured to cause at least one of the at least one processor to obtain an image description model and a description prompt text, the description prompt text indicating an image description rule for performing image description by the image description model; and
third obtaining code configured to cause at least one of the at least one processor to:
input the description prompt text and the image into the image description model; and
perform image description on the image based on the description prompt text through the image description model to obtain a first image description text that conforms to the image description rule,
wherein the description prompt text is obtained by correcting an initial prompt text corresponding to the image description rule based on a first text difference between a sample image description text and a predicted image description text,
wherein the sample image description text is obtained based on a sample image and the image description rule, the predicted image description text being obtained by the image description model performing image description on the sample image based on the initial prompt text, and
wherein the initial prompt text is initialized based on the image description rule.

13. The image description apparatus according to claim 12, wherein the program code further comprises a correction code configured to cause at least one of the at least one processor to:
perform initialization based on a preset image description rule, to obtain the initial prompt text;
input the initial prompt text and the sample image into the image description model;
perform image description on the sample image based on the initial prompt text through the image description model, to obtain a predicted image description text;
obtain the sample image description text based on the image description rule and the sample image;
obtain the first text difference based on the sample image description text and the predicted image description text; and
correct the initial prompt text based on the first text difference, to obtain the description prompt text.

14. The image description apparatus according to claim 12, wherein the program code further comprises first update code configured to cause at least one of the at least one processor to:
display a description text adjustment interface including an image text display area and a text adjustment area, the image text display area being configured for displaying the first image description text;
adjust the first image description text in the text adjustment area based on a modification operation on the first image description text, to obtain a second image description text; and
update the image text display area to replace the first image description text with the second image description text.

15. The image description apparatus according to claim 14, wherein the program code further comprises second update code configured to cause at least one of the at least one processor to:
add the second image description text to the sample image description text, to update the sample image description text.

16. The image description apparatus according to claim 14, wherein the program code further comprises second update code configured to cause at least one of the at least one processor to:
obtain a comparison text of the first image description text and the second image description text; and
update the image text display area to replace the first image description text to the second image description text based on the comparison text meeting a preset text modification completion condition.

17. The image description apparatus according to claim 12, wherein the program code further comprises fourth obtaining code configured to cause at least one of the at least one processor to:
obtain an instruction prompt text based on the sample image description text, the instruction prompt text including an image description instruction and sample description text corresponding to the image description instruction;
guide, based on the image description instruction, the image description model to perform image description on a sample image, to obtain a predicted description text;
obtain a second text difference based on the predicted description text and the sample description text;
perform parameter optimization and iteration on the image description model based on the second text difference and the instruction prompt text, until the second text difference meets a preset convergence condition;
input, based on the second text difference meeting the preset convergence condition, the description prompt text into the image description model; and
perform image description on the image through the image description model, to obtain the first image description text that conforms to the image description rule.

18. The image description apparatus according to claim 12, wherein the image includes at least two images, and
wherein the third obtaining code is configured to further cause at least one of the at least one processor to:
perform feature extraction on the at least two images through the image description model, to obtain image labels corresponding to each of the at least two images;
input the description prompt text into the image description model;
obtain a screening label based on the image description rule;
screen the at least two images based on the screening label and the image labels, to obtain another image associated with the image description rule, and a target image; and
perform image description on the target image through the image description model, to obtain the first image description text that conforms to the image description rule.

19. The image description apparatus according to claim 18, wherein the target image includes at least two target images, and
wherein the third obtaining code is configured to further cause at least one of the at least one processor to:
obtain the image labels corresponding each of the at least two target images;
divide the at least two target images based on the image labels, to obtain target images with the same label; and
perform image description on the target images with the same label through the image description model, to obtain the first image description text that conforms to the image description rule.

20. A non-transitory computer-readable storage medium, storing computer code which, when executed by at least one processor, causes the at least on processor to at least:
obtain an image;
obtain an image description model and a description prompt text, the description prompt text indicating an image description rule for performing image description by the image description model;
input the description prompt text and the image into the image description model; and
perform image description on the image based on the description prompt text through the image description model, to obtain a first image description text that conforms to the image description rule,
wherein the description prompt text is obtained by correcting an initial prompt text corresponding to the image description rule based on a first text difference between a sample image description text and a predicted image description text,
wherein the sample image description text is obtained based on a sample image and the image description rule,
wherein the predicted image description text is obtained by the image description model performing image description on the sample image based on the initial prompt text, and
wherein the initial prompt text is initialized based on the image description rule.
